(19) United States
(12) Patent Application Publication
(10) Pub. No.: US 2011/0227584 A1
(43) Pub. Date: Sep. 22, 2011

(54) INSULATION TEST METHOD FOR LARGE-SCALE PHOTOVOLTAIC SYSTEMS

(76) Inventor: Bernhard BECK, Volkach OT Dimbach (DE)

(21) Appl. No.: 13/049,508

(22) Filed: Mar. 16, 2011

(30) Foreign Application Priority Data
Mar. 16, 2010 (DE) DE102010011476.6

(51) Int. Cl. H01H 31/12

(52) U.S. Cl. 324/551

(57) ABSTRACT

In large-scale photovoltaic systems, it is not appropriate to use a conventional insulation monitor, since its test pulse is damped too much by the number and length of the feed lines. According to an embodiment of the invention, a remedy is provided here in that the photovoltaic system is subdivided through circuit design into multiple subsystems that are electrically insulated from one another, and the test pulse is transmitted to the connecting line associated with the applicable subsystem in sequential order. According to a second embodiment, the behavior of the current of the test pulse through the connecting lines is sensed by current sensors and evaluated in an analysis unit.

This nonprovisional application claims priority under 35 U.S.C. §119(a) to German Patent Application No. DE 10 2010 011 476.6, which was filed in Germany on Mar. 16, 2010, and which is herein incorporated by reference.

### BACKGROUND OF THE INVENTION

1. Field of the Invention

The invention relates to a method for testing the insulation of a photovoltaic system from ground with the aid of a test pulse transmitted to the connecting lines of the photovoltaic system.

2. Description of the Background Art

A method for protecting a PV system is known from WO95/25374. This method reacts once damage has already occurred, in that an attempt is made to limit the effects of the damage on the photovoltaic system by the means that the electromagnetic radiation accompanying the short-circuit arc is detected and the affected system components are isolated from the short-circuit.

Known from the document DE 10 2004 018918 is an insulation fault localization method in the field of alternating current, in which each subnetwork that can be connected is provided with its own test generator, its own insulation monitoring device, and its own differential current transformer.

U.S. Pat. No. 5,155,441 describes an AC system in which a single insulation tester is used sequentially to monitor multiple motors, which must be deenergized and stationary then.

Lastly, it is known from DE 69213626 to supply multiple AC subnetworks through associated circuit breakers. Coupling switches serve to establish a predefinable network configuration. Each network section then has a separate overall insulation monitor associated with it, and each branch of each network section has a local insulation monitor.

The method mentioned at the outset is customary in photovoltaic systems for early detection of a ground fault or an impending insulation weakness. To this end, an insulation monitor is attached to the connecting lines; said insulation monitor generates the test pulse and transmits it to the connecting lines. In this design, the test pulse is transmitted at the input of the inverter, which converts the photovoltaically generated direct current into alternating current for feeding into a supply grid. Today, inverters of up to a MW are available as a result of advances in semiconductor technology for power transistors. In the associated large-scale systems, the use of the classical insulation monitor is not successful, since the size of the wiring system that is present results in excessively high capacitances that damp the test pulse such that no reliable statement can be made about the state of the insulation. To date, modifications to the insulation monitors have not provided a satisfactory solution.

### SUMMARY OF THE INVENTION

It is therefore an object of the present invention to provide a remedy here, and also to be able to check photovoltaic systems of any desired size using a standard test device.

This object is attained in accordance with a first embodiment of the invention in that the photovoltaic system is subdivided through circuit designs into multiple subsystems that are electrically insulated from one another, and the test pulse is transmitted to the connecting line associated with the applicable subsystem in sequential order.

Thus, this method does not take the obvious route of further developing the tester, but instead pursues the course of changing the photovoltaic system, or rather making it more easily subdivided, in such a way that standard testers can be used. This can involve higher device costs, but at an acceptable level.

The breakdown into subsystems by circuit design means should be accomplished in such a manner that each subsystem comprises multiple photovoltaic arrays, namely a sufficient number that their line lengths can be managed by the pulse tester used. The lines here can be connected to a bus bar, which itself is routed to the input of an inverter.

The connection to the subsystems, if applicable to the individual PV arrays, should be connected through a two-pole switching means to the output of an insulation monitor that generates the test pulse. For this purpose, a multiplexer may be located in the insulation monitor, which sequentially transmits a test signal to the lines to the relevant subsystems connected to the output of the multiplexer. Alternatively, the two-pole switching means can comprise a plurality of electronic switches that connect the relevant pair of connecting lines leading to the subsystems to a test pulse bus bar or isolates them therefrom, with the test pulse being transmitted on said test pulse bus bar and distributed from there via the switching means to the individual subsystems.

According to a second embodiment of the invention, the object is attained in that the behavior of the current of the test pulse through the connecting lines is sensed by current sensors at suitable locations. Here, as well, modifications are made to the system, requiring a one-time increased use of material and installation effort; however, this is compensated for by the advantages of the use of standard equipment for insulation monitoring.

It is advantageous to generate a first series of measurement pulses at a point in time close to the installation of the system and to document their behavior, branching, and/or distribution in the network of the connecting lines to the one or more PV arrays. In this way, a reference is generated, e.g., immediately after installation of the photovoltaic system, as to what the insulation should look like in the ideal case without the occurrence of degradation from contamination, aging, increases in contact resistance, etc. After a selectable period of time has elapsed, the behavior of the test pulse is compared with the corresponding behavior at the earlier point in time. Conclusions concerning insulation deficiencies that have arisen in the meantime can then be drawn from the changes.

The current sensors can be provided at the feed lines leading to individual arrays of the photovoltaic system proceeding from a bus bar. This is especially advantageous when additional switching means are provided that connect the relevant connecting lines leading to the individual arrays to the bus bar or isolate said connecting lines therefrom. The bus bar is connected to the input of the inverter here.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a device for carrying out the method according to a first embodiment with current monitoring,

FIG. 2 illustrates a device for carrying out the method according to a second embodiment with test pulse bus bar, and

FIG. 3 illustrates a device for carrying out the method according to a third embodiment with a multiplexer.

### DETAILED DESCRIPTION

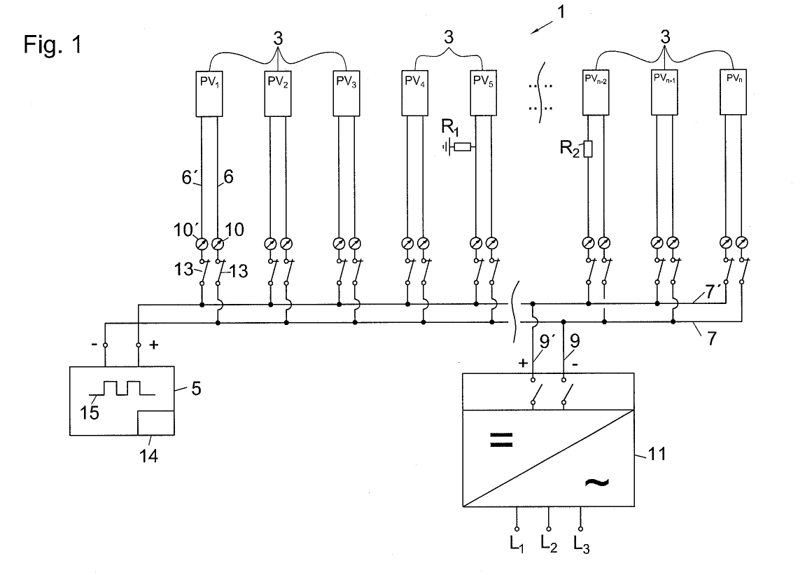

Shown in FIG. 1 is a large-scale photovoltaic system 1, which is subdivided into n subsystems 3. The first five subsystems 3 are also labeled PV1 through PV5, and the last two subsystems 3 are labeled PVn-1 and PVn. Each of the subsystems 3 comprises multiple parallel-connected photovoltaic arrays, for example 8 arrays (not shown). A customary size for an array, in turn, is ten parallel-connected strings of 10 series-connected photovoltaic modules. Each module in turn has, e.g., 60 series-connected photocells. Eight arrays of 10 strings apiece yields 80 strings. Ten strings of 10 PV modules apiece, then, results in 800 PV modules per subsystem 3. This is an order of magnitude in which it makes sense to use a conventional insulation monitor 5.

In currently available large-scale PV systems, for example, n=20 of these subsystems 3 are connected directly to two bus bars 7,7′ through feed lines 6,6′, which are connected to the respective plus and minus inputs 9 of an inverter 11. Provided in the power lines 6,6′ are current transformers 10,10′, of which it is preferable for one 10′ to be provided in the line 6′ leading to the positive pole 9′ of the PV system and one 10 to be provided in the line 6 leading to the negative pole 9.

From the bus bars 7,7′ connected to an inverter 11, the feed lines 6,6′ lead to the subsystems 3 through a 2-pole disconnect switch 13. Because of the high current to be switched, the disconnect switch 13 is a mechanical switch 13, which draws a considerable arc during the actual switching process, resulting in wear of the switch contacts. Switching activities should be managed in a correspondingly sparing manner.

This is permitted by the instant first embodiment in that the insulation monitor 5 transmits its test pulse 15 directly to the bus bars 7,7′ without needing to have actuated the disconnect switches 13. For example, this can be done at night, when no solar-generated voltage is present. With suitably high-resistance insulation of the insulation monitor 5, the test pulse 15 can also be modulated onto the bus bars 7,7′ in the daytime during ongoing operation of the photovoltaic system 1.

If the feed lines 6,6′ to all subsystems 3, as well as the subsystems 3 themselves, are in a properly insulated state, then the test pulse 15 transmitted on the positive bus bar 7′ would be distributed more or less uniformly over the subsystems 3 in accordance with the particular line lengths present, and the ammeters 10′ would indicate approximately the same value. The ammeters 10 measuring the return current likewise indicate the same current value except for the damping losses that are to be expected.

In FIG. 1, two resistances R1 and R2, which symbolically represent an irregularity, are shown in the feed lines 6,6′ to the subsystems PV5 and PV n-2. The resistance R1 can be, e.g., a secondary current path that arises when grass grows onto an exposed cable core. At this location, the ammeter 10′ would indicate a higher value than the ammeter 10, since the test pulse 15 is not completely returned to the bus bar 6, but instead was partially conducted to ground. Analogously, the resistance R2 is, for example, a degraded contact transition that has arisen over time. This would become noticeable in that, although the associated current transformers 10,10′ of the subsystem PVn-2 measure the same value, this value is significantly lower than the current values measured at the other subsystems PVn. In this way, the state of the insulation in the relevant subsystems PVn can be inferred from analysis of the behavior of the current in the feed lines 6,6′. A suitable analysis unit 14 can be integrated into the insulation monitor 5.

Immediately following the installation of the PV system 1, a series of test pulses 15 can be transmitted to the feed lines 6,6′ for the first time. Assuming that all insulation weaknesses identified during the setup phase have been remedied, a reference distribution of the currents, which reflects how the test pulse 15 propagates within the system 1, is thus provided. The measured currents from all current transformers 10,10′ that are present are documented so that they are available at a later comparison measurement. The analysis unit 14 then determines how the current distribution has changed, and issues a warning signal in the event of an unacceptably high change of, e.g., plus/minus 10% deviation from the original measured value.

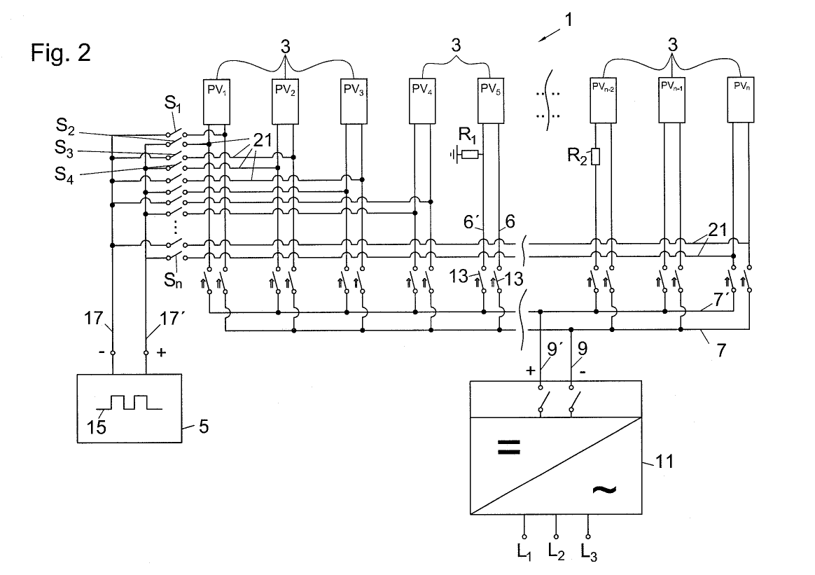

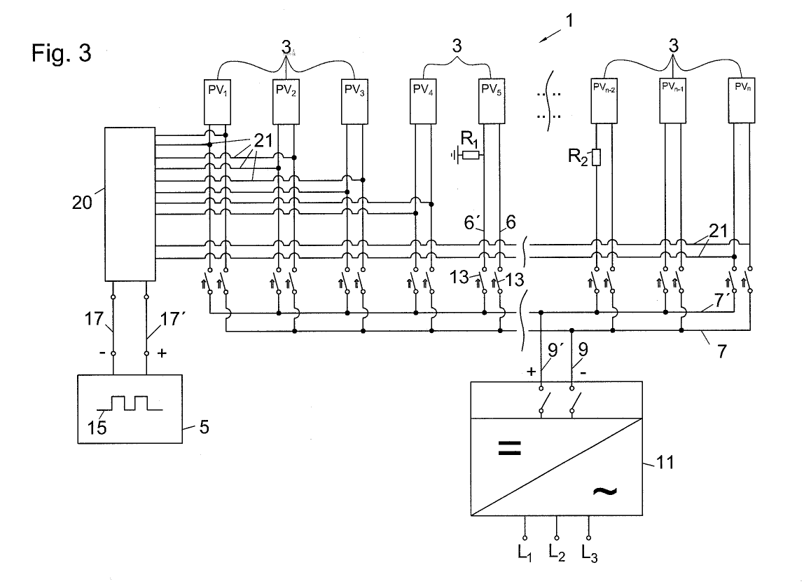

In the second embodiment of the invention shown in FIG. 2, the insulation monitor 5 transmits the test pulse 15 on two test pulse bus bars 17,17′, whence it can be switched according to the invention by means of two or more two-pole switches S onto connecting lines 21,21′, also referred to below in connection with FIG. 3 as stub lines 21,21′, each of which terminates in associated feed lines 6,6′.

If the first subsystem PV1 is to be tested for insulation weaknesses, then all other switches S2 to Sn of the subsystems PV2 to PVn are opened, and only the switch S1, which connects the feed lines 6,6′ of the first subsystem PV1 to the test pulse bus bars 17,17′, is closed. In this way it is made possible, even for the large-scale system 1, to test the insulation with a conventional insulation monitor 5 in the accustomed manner.

In this way, all subsystems PVn are gradually connected to the insulation monitor 5, by the means that only the relevant switch S that is associated with the subsystem PV to be tested is closed, while all other switches S remain open. This subdivision of the overall system 1 into subsystems 3, each of which is connected to the insulation monitor 5 via the switches S1 to Sn, is to be understood as division as defined in the claims.

FIG. 3 shows a third variant in which the switches S are replaced by a multiplexer 20 to the outputs of which are connected the feed lines or stub lines 21 that conduct the test pulse 15 from the multiplexer 20 to the feed lines 6,6′.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for testing an insulation of a photovoltaic system from ground by a test pulse transmitted to a connecting line of the photovoltaic system, the method comprising:
subdiving the photovoltaic system through circuit design means into multiple subsystems that are electrically insulated from one another; and
transmitting the test pulse is transmitted to the connecting line associated with the applicable subsystem in sequential order.

2. A method for testing an insulation of a photovoltaic system from ground by a test pulse transmitted to a connecting line of the photovoltaic system, the method comprising:
sensing a behavior of a current of the test pulse through the connecting lines by at least one current sensor; and
evaluating the behavior in an analysis unit.

3. The method according to claim 2, wherein the behavior of the test pulse is compared with a corresponding behavior at an earlier point in time.

4. The method according to claim 2, wherein the current sensor is employed at the feed line leading to the subsystems of the photovoltaic system proceeding from a bus bar.

5. The method according to claim 2, wherein a switch is configured to connect relevant connecting lines leading to individual subsystems to two bus bars or isolate the connecting lines therefrom, and wherein the bus bars are connectable to an input of an inverter.

6. The method according to claim 5, wherein an additional switching is configured to connect the relevant connecting lines leading to the individual subsystems to a test pulse bus bar, on which the test pulse is transmitted, or isolate said connecting lines therefrom.

7. The method according to claim 1, wherein each subsystem comprises multiple photovoltaic arrays and are individually adapted to be connected to a bus bar that is routed to an input of an inverter.

8. The method according to claim 1, wherein each subsystem is connectable through a two-pole switching to an output of an insulation monitor that generates the test pulse.

9. The method according to claim 8, wherein the two-pole switching is a multiplexer, which sequentially transmits the test signal to connecting lines connectable to the output of the multiplexer, each of which lines leads to the lines for the applicable subsystems.

10. The method according to claim 8, wherein the two-pole switching comprises a plurality of electronic switches that connect the relevant pair of connecting lines leading to the subsystems to a test pulse bus bar or isolate them therefrom, with the test pulse being transmitted on the test pulse bus bar and distributed from there to the individual subsystems.
